(19) United States
(12) Patent Application Publication
(10) Pub. No.: US 2020/0234236 A1
(43) Pub. Date: Jul. 23, 2020

(54) METHODS AND SYSTEMS FOR LINKING SPECIFIC INFORMATION TO INDIVIDUAL PRODUCT UNITS

(71) Applicant: STEVANATO GROUP S.P.A., Padova (IT)

(72) Inventor: Christophe BUREAU, Grenoble (FR)

(73) Assignee: STEVANATO GROUP S.P.A., Padova (IT)

(21) Appl. No.: 15/737,036

(22) PCT Filed: Feb. 10, 2016
(86) PCT No.: PCT/EP2016/052780

§ 371 Date: Dec. 15, 2017

(51) Int. Cl. G06Q 10/08; G06K 19/07; G06K 7/10

(52) U.S. Cl. CPC G06Q 10/0875; G06K 7/10712; G06K 19/0723

(57) ABSTRACT

The method linking information in a database to a specific product unit in a production run and making this information available to a user comprises the steps of providing each product unit with a unique identifier tag, providing a database having units of information and image information of each unique identifier tag; linking at least one of said units of information to each of said unique identifier tags; and providing a user with a reader being able to read said unique identifier tag. The reader reads said unique identifier tag as image information and said request system compares said unique identifier tag image information from said reader with said said unique identifier tag image information stored in the database to retrieve said at least one unit of information linked to said unique identifier tag and provides said information linked to said unique identifier tag to said user.

### TECHNICAL FIELD

The present invention relates to methods and systems for linking specific information to individual product units.

In particular the present invention relates to methods and systems for linking information in a database to a specific product unit in a production run and making this information available to a user.

### TECHNICAL BACKGROUND

During the manufacture and sale of products in the industrial and some might argue post-industrial age an item passes through various hands. An insulin cartridge for example starts its life as a glass tube that is turned into a cartridge by the cartridge manufacturer. The cartridge is then sent to a pharmaceutical company to be filled with insulin. From the pharmaceutical company the cartridge will make its way via one or several wholesalers and logistics companies to the pharmacy and ultimately to the patient.

During the lifecycle of a product it can be important for a user to identify an individual product unit such an individual cartridge and to obtain information specific for this cartridge. Such information can for example include the manufacturing parameters of the cartridge, the specification of the insulin filled into the cartridge, the time and conditions of filling, the lot number or even just the information that the cartridge is a genuine product and not counterfeit.

While it is known to put tags such as barcodes or QR-codes on product units these codes are often not specific enough and merely relate to a lot of product units rather than product units.

In order to overcome the issue a product unit can be tagged with a unique identifier which can be read using a reader that can contact a database and retrieve information from the database based on the tag. The present applicant has for example described such a system that can be used to specifically provide selected information to distinct user groups. Such a system is described in co-pending U.S. patent application 62/129,055.

While it is possible to implement such a system based on a tag such as a barcode or a QR-code the applicant has now discovered that the use of barcodes or QR-codes is not always the best option. If for example a product is already provided with a barcode and for example for legal or administrative reasons must be provided with a specific barcode such as a GS 1 databar it would be necessary to apply a second barcode making the identification of the correct barcode more difficult.

Furthermore in some cases there a legal and administrative restrictions on the number and types of barcodes that can be attached to a product unit.

In addition in some cases a manufacturer might not want to make it directly obvious that a product has been provided with a specific tag, be it for added security in case the tag is used as an anti-counterfeiting tool or be it simply for aesthetic reasons.

### SUMMARY OF THE INVENTION

The present inventors have now discovered that individual product units can be provided with identifier tags in the form of images. It is then possible to use image recognition to detect differences between the images applied to individual product units and use these differences between the images to identify the individual product unit. This information can then be used to access a database to provide a user with information specific to the individual product unit.

This has the advantage that individual product units can be provided with a link to specific information relating to the individual product unit even in situation where the use of barcodes or QR-codes is not possible or not desired.

According to one aspect of the invention there is provided a method for linking information in a database to a specific product unit in a production run and making this information available to a user comprising the steps of:

a.) providing each product unit in a production run of at least two product units with a unique identifier tag,

b.) providing a database, the database comprising units of information as well as the image information of each unique identifier tag;

c.) linking at least one of the units of information to each of the unique identifier tags; and

d.) providing a user with a reader, the reader being able to read the unique identifier tag and comprising a request system for accessing the units of information stored in the database based on the image information of the unique identifier tag;

wherein the reader is configured to read the unique identifier tag as image information and the request system is configured to initiate a comparison between the image information of the unique identifier tag read by the reader with the image information of the unique identifier tags stored in the database to retrieve the at least one unit of information linked to the unique identifier tag and provides the information linked to the unique identifier tag to the user.

While the individual steps in the method of the invention are displayed in a certain order and labelled a.) to d.) this is merely done to identify individual steps and there is no need to perform the steps in the order given. In the method of the invention the various steps can be performed in a different order without departing from the spirit of the invention.

In another aspect of the invention there is provided a system for linking information in a database to a specific product unit in a production run and making this information available to a user, the system comprising,
at least one production run, the production run comprising at least two product units, each of the product units being provided with a unique identifier tag;
a database, the database comprising units of information as well as the image information of each unique identifier tag, at least one of the units of information being linked to each of the unique identifier tags; and
at least one reader, the reader being able to read the unique identifier tag and comprising a request system for accessing the units of information stored in the database based on the image information of the unique identifier tag;
   wherein the reader is configured to read the unique identifier tag as image information and the request system is configured to initiate a comparison between the image information of the unique identifier tag read by the reader with the image information of the unique identifier tags stored in the database to retrieve the at least one unit of information linked to the unique identifier tag and provides the information linked to the unique identifier tag to the user.

While it is possible and some cases desirable to use obviously differing pictures as unique identifier tags it can be advantageous to use pictures as identifier tags that at first glance look identical or very similar and differ only in very small ways to identify the product unit. It is possible that the differences in the unique identifier tags are such that they are imperceptible or nearly imperceptible to the naked human eye. In some cases the differences between the unique identifier tags might be perceived as production imperfections by an uninformed user.

While in general the unique identifier tag will be visible to the human eye it is conceivable that the unique identifier tag is provided in a way that is not visible to the naked eye for example by using inks that only interact with light outside the visible spectrum such as UV-active inks. In those cases it might be necessary to provide the user with an indication as to where the unique identifier tag is placed on the product or provide the product with multiple versions of the unique identifier tag. It is also possible that an invisible tag is superimposed over a visible feature such as a company or product logo.

It is even possible that the unique identifier tag is in the form of e.g. a bar code or a QR-code but in this case it needs to be understood that the reader does not read the bar code in the conventional way, i.e. the reader does not translate the information in the barcode for example into a number. The reader merely reads the image information and compares this information via the request system with the image information stored in the database. It is thereby possible that the barcode or QR-code can still be read using e.g. a conventional barcode scanner to provide information contained in the barcode or QR-code. In this case it might be useful if the identifying features for each of the individual unique identifier tag are very small and preferably imperceptible to the naked human eye. In this case, obviously, the identifying features furthermore must not interfere with the correct function of the barcode or QR-code.

The units of information supplied to the user can for example include data used in the tracking and tracing of goods such as GS 1 data including but not limited to identification number, lot number, expiry date; digital content or links thereto associated with the product, for example an image, a video clip or an Augmented Reality (AR) sequence, i.e. a special virtual environment appearing on the screen of the device, but also more dynamic information such as stocks of a product in a local shop or pharmacy or information on product recalls. In another embodiment, the information may be interactive, e.g. a game to be played by the user,

In some aspects of the invention the database in stored on a computer system and in particular on a cloud system.

In some aspects of the invention the unique identifier tag is incorporated into the packaging or is formed by at least a part of the packaging.

In this case the unique identifier tag can for example be formed by a companies logo or the logo of the particular product or part of the general appearance of the product. This has the advantage that the presence of the unique identifier tag can be hidden from an uninformed user. In some cases it is even conceivable to incorporate the unique identifier tag into the three dimensional shape of the product or the packaging.

The unique identifier tag will be attached to or part of the product itself or at least one part of its packaging, such as the primary packaging (e.g. a container for a liquid product or a product in powder form) or the secondary packaging (e.g. a box for the primary packaging). In general the unique identifier tag will be attached to at least one of the primary packaging and the secondary packaging. In case the unique identifier tag is attached to the tertiary or higher order packaging the tertiary of higher order packing containing individual units is considered a product unit in itself. In the latter case, according to the invention, again there must be at least two differing product units and identifier tags in the production run and every product unit must be provided with a specific unique identifier tag.

In some aspects of the invention the unique product identifier is attached to multiple levels of packaging up to and including all levels of packaging.

The expression reader relates to any device that can read the unique identifier tag, communicate the image information of the unique identifier tag to the database and receive and communicate the at least one unit of information linked to the unique identifier tag and received from the database to the user.

Examples of electronic devices that can read the unique identifier tags are generally known. Such devices include both stationary and mobile computers with a suitable camera or mobile telephones or tablets, again with a suitable camera.

The reader further has a request system for accessing the units of information stored in the database based on the image information of the unique identifier tag. The access to the database can take place by any means know to a person skilled in the art and will most likely take place using a data connection such as a wired WAN or LAN, a WiFi connection or a mobile telephony or data connection. It is nevertheless possible to use other means of access such as landline telephone connections, other wireless connections such as Bluetooth or dedicated radio networks or dedicated wired connections.

In some cases the hardware of the reader, e.g. in the form of a mobile phone or a computer is already present with the user. In this case the reader of the method/system of the invention is provided by installing the request system usually in the form of a piece of software on the respective hardware.

In some aspects of the invention the reader is selected from the group consisting of camera equipped computers, camera equipped PDAs, camera equipped mobile telephones and camera equipped tablets.

In some aspects of the invention the reader is a smartphone with a camera, especially a smartphone with the capability to connect to the Internet.

In some aspects of the invention the request system is an application running on a smartphone.

In some aspects of the invention the reader is a camera connected to a computer.

In some aspects of the invention the product is selected from the group consisting of medical devices, drug products, personal care products, nutritional supplements, nutraceuticals, functional foods and foodstuffs.

In some aspects of the invention the reader provides further information to the user, While it is possible to provide further information specific to the individual product unit it is also possible to provide further information specific to a lot of product units or all product units. Examples for information common to all product units could be the provision of instructions for the use of the product. This information as well as the product specific information can be in any form such as e.g. written, as a film or animation or as an augmented reality sequence.

### BRIEF DESCRIPTION OF THE DRAWINGS

The invention will now be illustrated in more detail based on a select example and taking reference to the enclosed drawings in which

FIG. 1 shows a schematic representation of a first step of the method of the invention,

FIG. 2 shows a schematic representation of a second step of the method of the invention,

FIG. 3 shows a schematic representation of a third step of the method of the invention, and

FIG. 4 shows a schematic representation of a fourth step of the method of the invention.

### DETAILED DESCRIPTION OF PREFERRED EMBODIMENTS

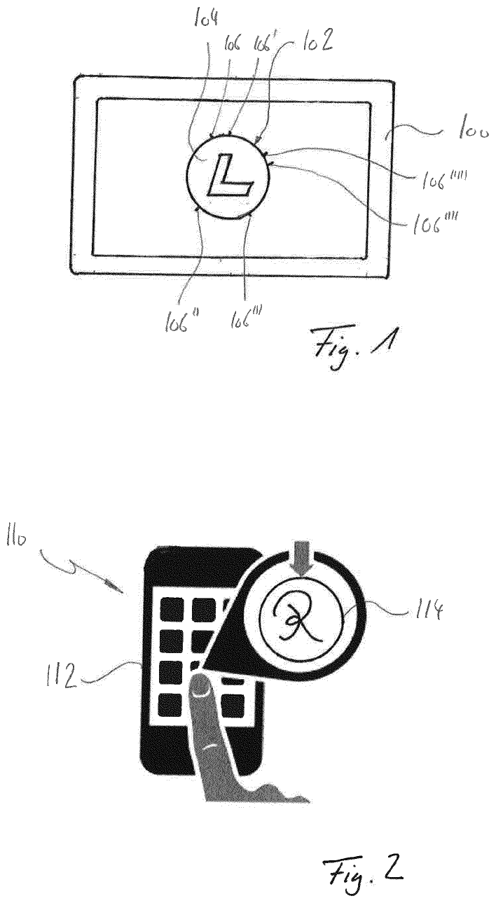

Reference will now be made to preferred embodiments of the invention based on a specific example and taking reference to the enclosed drawings, in which FIG. 1 shows a container 100 containing insulin cartridges which, in this instant, is shown in top view, The top of the container 100 is closed with a polymer film that can be peeled off to access the insulin cartridges packed inside the container 100. On the top of the container 100 there is provided the unique product identifier 102 consisting of the logo of the manufacturer 104 here symbolically represented by the stylized letter “L” in a circle. Arranged on the periphery of the circle are short black lines 106, 106′, 106″, 106″′, 106″″ and 106″″′ (hereinafter generally collectively referred to as lines 106) radiating out from the circle. The number, position, length and thickness of these lines 106 is used to form the identifying image information of the unique product identifier 102. Due to the number of possible variations of the number, position, length and thickness of these lines 106 it is possible to provide and almost unlimited number of unique product identifiers 102.

During the production process of a package of insulin cartridges in a first step the cartridges are formed form a glass tube. At this point in time the cartridge is provided with its own unique product identifier, similar to the unique product identifier 102 of the container 100. Once this has happened a first entry into a database is created for this cartridge. Information that is linked to the cartridge identifier is e.g. the date of manufacturing, the supplier of the raw material (i.e. the glass tube) and the flame temperature at which the cartridge was produced.

After the manufacture the cartridge is transported to a pharma company and filled with insulin. After the filling step the cartridge is inspected and further information linked to the individual cartridge is added to the database. Information added in this step can for example include batch numbers and possibly the manufacturer for the insulin used, the date and time of filling and the results of the quality control. It is furthermore possible to add an entry that can be used for product tracking or to validate that the cartridge is an original and not counterfeit. Once the cartridges are filled and inspected they are packed into containers such as the container 100 and each container is provided with its unique product identifier. At this step the first information is added to the database that is linked to the unique product identifier 102 of the container 104. Information added includes the date and place of packing, references to the unique product identifiers of the cartridges contained in the container 100 and entries relating to product tracking and the validation that the container 100 is genuine and not counterfeit. Once the container 100 is packed it is shipped via the wholesalers to the pharmacist and possibly to the final consumer. During the further transport more entries can be made to the database for example for product tracking.

If a user, be this a member of the product and/or logistics chain or a pharmacist or an end-user wants to access the information relating to the container 100 stored in the database he can use a reader 110, here in the form of a smartphone 112 equipped with a camera as shown in FIG. 2. On this smartphone there is an app 114 installed, here represented symbolically with the stylized letter “R” in a circle, which forms the request system.

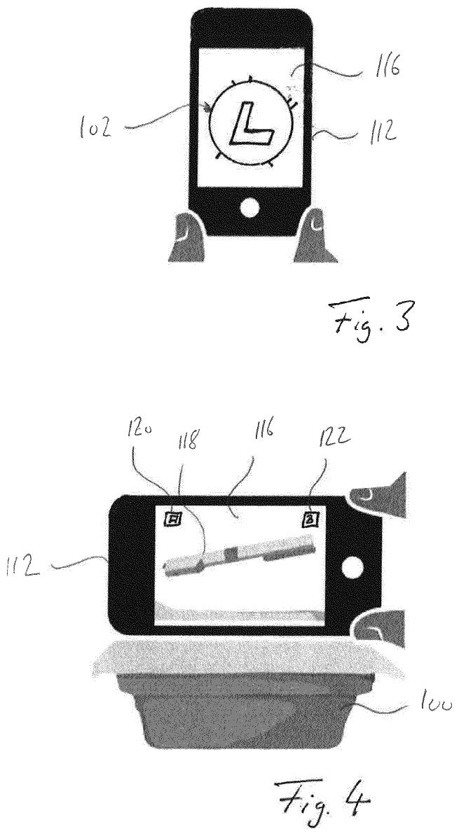

The user starts the app 114 then points the camera of the smartphone 112 at the logo 102. The app 114 the acquires the image information captured by the camera and displayed on the screen 116 of the smartphone and contacts the database transmitting the image information to the database using a mobile data connection (see FIG. 3).

Once the database has located the specific information linked to the unique product identifier 102 the database transmits the information to the app 114 and the app 114 displays the information on the screen 116 of the smartphone. In the instant case the app 114 begins by displaying an augmented reality sequence showing the polymer film being peeled off and a cartridge 118 being extracted from the container 100. Furthermore the app 114 displays two buttons in the top left and top right corner of the screen 116 of the smartphone 112. These buttons are symbolically represented with the letter “A” (button 120) and “B” (button 122). By pressing these buttons the user can access specific information linked to the container 100. For example the user can check that the container 100 is a genuine product and not counterfeit by pressing button 120. By pressing button 122 the user is provided with details of the packaging date and place of the container as well as the origin of the cartridges packed therein.

While the present invention has been described in connection with a number of select exemplary embodiments and implementations the present invention is not limited thereby but cover all modifications and equivalents falling within the scope and the spirit of the claims

1. A method linking information in a database to a specific product unit in a production run and making this information available to a user, comprising the steps of:
providing each product unit in a production run of at least two product units with a unique identifier tag;
providing a database, said database comprising units of information and image information of each unique identifier tag;
linking at least one of said units of information to each of said unique identifier tags; and
providing a user with a reader, said reader being able to read said unique identifier tag and comprising a request system for accessing said units of information stored in said database based on said unique identifier tag;
wherein the reader is configured to read said unique identifier tag as image information and said request system is configured to initiate a comparison between said image information of said unique identifier tag read by said reader with said image information of said unique identifier tags stored in the database to retrieve said at least one unit of information linked to said unique identifier tag and provides said information linked to said unique identifier tag to said user.

2. The method of claim 1 wherein said database is stored on a computer system.

3. The method of claim 2, wherein said database is stored on a cloud system.

4. The method of claim 1, wherein said unique product identifier is at least one of incorporated into the packaging or formed by at least a part of the packaging.

5. The method of claim 1 wherein said reader is selected from the group consisting of camera equipped computers, camera equipped PDAs, camera equipped mobile telephones and camera equipped tablets.

6. The method of claim 5, wherein said mobile telephone is a smartphone.

7. The system of claim 6 wherein said request system is an application on said smartphone.

8. The method of claim 1, wherein said product is selected from the group consisting of medical devices, drug products, personal care products, nutritional supplements, nutraceuticals, functional foods and foodstuffs.

9. A system linking information in a database to a specific product unit in a production run and making this information available to a user said system comprising,
at least one production run, said production run comprising at least two product units, each of said product units being provided with a unique identifier tag;
a database, said database comprising units of information as well as said image information of each unique identifier tag, at least one of said units of information being linked to each of said unique identifier tags; and
at least one reader, said reader being able to read said unique identifier tag and comprising a request system for accessing said units of information stored in the database based on the unique identifier tag;
wherein the reader is configured to read said unique identifier tag as image information and said request system is configured to initiate a comparison between said image information of said unique identifier tag read by said reader with said image information of said unique identifier tags stored in the database to retrieve said at least one unit of information linked to said unique identifier tag and provides said information linked to said unique identifier tag to said user.

10. The system of claim 9 wherein said database is stored on a computer system.

11. The system of claim 10, wherein said database is stored on a cloud system.

12. The system of claim 9 wherein said unique product identifier is incorporated into the packaging or is formed by at least a part of the packaging.

13. The system of claim 9 wherein said reader is selected from the group consisting of camera equipped computers, camera equipped PDAs, camera equipped mobile telephones and camera equipped tablets.

14. The system of claim 13, wherein said mobile telephone is a smartphone.

15. The system of claim 14, wherein said request system is an application on said smartphone.
